(19) United States
(12) Patent Application Publication
(10) Pub. No.: US 2022/0219499 A1
(43) Pub. Date: Jul. 14, 2022

(54) METHOD OF INFLATING A TIRE AND CENTRAL TIRE INFLATION SYSTEM

(71) Applicant: Dana Motion Systems Italia S.R.L., Reggio Emilia (IT)

(72) Inventors: Biagio BORRETTI, Modena (IT); Alessandro BENEVELLI, Reggio Emilia (IT); Luca RICCÒ, Parma (IT)

(21) Appl. No.: 17/573,486

(22) Filed: Jan. 11, 2022

(30) Foreign Application Priority Data
Jan. 13, 2021 (DE) 10 2021 200 236.6

(51) Int. Cl. B60C 23/06; B60C 23/04; B60T 8/172; B60W 40/12

(52) U.S. Cl. CPC B60C 23/064; B60C 23/0408; B60C 23/0488; B60T 2240/06; B60W 40/12; B60T 2210/14; B60T 8/1725

(57) ABSTRACT

The present disclosure relates to a method of inflating a tire and a central tire inflation system. The system has the tire connected to a pressure port for applying an air pressure via a pneumatic line. An ambient air temperature and a target pressure for the tire is received and a tire inflation rate based on the ambient air temperature and the target pressure is calculated. An estimated pressure of the tire based on tire inflation rate is estimated and the tire is inflated at the calculated tire inflation rate. A pressure of the tire is measured and a correction factor based on a ratio between the measured pressure and the estimated pressure is calculated. The tire inflation rate using the correction factor is corrected and the tire is inflated at the corrected tire inflation rate until the target pressure is reached.

### CROSS-REFERENCE TO RELATED APPLICATION

The present application claims priority to German Patent Application No. 10 2021 200 236.6, entitled “METHOD OF INFLATING A TIRE AND CENTRAL TIRE INFLATION SYSTEM”, and filed on Jan. 13, 2021. The entire contents of the above-listed application is hereby incorporated by reference for all purposes.

### TECHNICAL FIELD

The present disclosure relates to a method of inflating at least one tire, such as at least one tire of a central tire inflation system (CTIS) and a corresponding central tire inflation system. A central tire inflation system is a system to provide control over the air pressure in a vehicle's tires, for instance to improve performance on different surfaces. For example, the pressure of a vehicle tire may be lowered to provide additional traction for the vehicle when the vehicle travels on soft terrain such as sand or mud, or the tire pressure may be raised to reduce the rolling resistance of the vehicle when the vehicle travels on an asphalt road.

### BACKGROUND AND SUMMARY

Tire inflation systems typically comprise a main fluid line for inflating and for deflating the tires, a wheel valve and a channel valve for each tire for controlling the processes of inflating and of deflating the respective vehicle tire, and a pressure sensor and a temperature sensor provided on the main fluid line. Central tire inflation systems may be installed on vehicles such as trucks or on working machines such as tractors, wheel loaders, dumpers, wheeled excavators, or the like.

In existing CTIS, the pressure sensor is disposed on the main fluid line. Therefore, a tire inflation control is based on tire pressure estimation during an inflation process, as a current pressure in the single tires cannot be read directly by the pressure sensor. Consequently, the pressure is estimated individually for any tire. The estimation is based on different inputs, including a temperature provided by the temperature sensor being part of the CTIS. Once the estimated pressure is equal to a target pressure, a real pressure is measured. This procedure is called “Pressure Check”.

The estimation of the tire pressure and the comparison of the estimated tire to the real tire pressure via valve control increases overall inflation time. Further, the temperature sensor of the CTIS increases costs and reduces reliability.

Based on the prior art, the objective of the present disclosure is to provide an improved method of inflating at least one tire of a central tire inflation system and/or a corresponding tire inflation system.

This problem may be solved by the disclosed methods and/or a central tire inflation system according to the present application.

Thus, a method of inflating at least one tire is presently proposed. The method comprises the following steps:

Providing a central tire inflation system having at least one tire connected to a pressure port for applying an air pressure via a pneumatic line,

Receiving an ambient air temperature and a target pressure for the at least one tire and calculating a tire inflation rate based on the ambient air temperature and the target pressure,

Estimating an estimated pressure of the at least one tire based on tire inflation rate, Inflating the at least one tire at the calculated tire inflation rate until the estimated pressure reaches a predetermined percentage of the target pressure,

Measuring a pressure of the at least one tire and calculating a correction factor based on a ratio between the measured pressure and the estimated pressure,

Correcting the tire inflation rate using the correction factor, Inflating the at least one tire at the corrected tire inflation rate until the target pressure is reached.

Among other things, this method has the advantage that a temperature sensor in the CTIS can be omitted.

The previously described method (if applicable, including further steps, being described in the following description) may be performed by a control device being part of a central tire inflation system.

The ambient temperature may be received by an Electronic Control Unit, like a Vehicle Control Unit or a Heating Ventilation and Air Conditioning (HVAC). These components typically comprise an Ambient Temperature Sensor. The ambient air temperature may be communicated via CAN or via other communication technologies.

Alternatively, the received ambient temperature may be assumed to be a predetermined value. The received ambient temperature may be assumed to be at least 10° C., at least 15° C., or at least 18° C. The received ambient temperature may be assumed to be at most 40° C., at most 30° C., or at most 25° C. For example, the received ambient temperature may be assumed to be 20° C.

The predetermined percentage of the target pressure may be adjustable. For example, in one embodiment, the predetermined percentage of the target pressure may be at least 50%, at least 60%, or at least 70% and/or the predetermined percentage of the target pressure may be at most 95%, at most 90%, or at most 85%. However, the predetermined percentage may be outside these ranges.

Advantageously, the central tire inflation system has at least two tires, for example at least four tires, connected to the pneumatic line.

In one embodiment, a first wheel valve and a supply valve are disposed along the pneumatic line. The first wheel valve may be disposed between the pressure port and a first tire of the at least one tire, the supply valve being disposed between the pressure port and the first wheel valve.

The first wheel valve and the supply valve may be selectively opened or closed.

The first wheel valve may be configured to control the processes of inflating and of deflating the first vehicle tire. The supply valve may be opened or closed to selectively fluidly connect the first tire with the pressure port.

For instance, the supply valve and the first wheel valve are opened for inflating the first tire at the calculated tire inflation rate, and the supply valve is closed to interrupt inflation of the first tire when the estimated pressure reaches the predetermined percentage of the target pressure.

For instance, a second wheel valve is disposed along the pneumatic line, the second wheel valve being disposed between the pressure port and a second tire of the at least one tire. The second wheel valve may be opened for inflating the second tire at the calculated tire inflation rate, and the supply valve is closed to interrupt inflation of the first tire and the second tire when the estimated pressure reaches the predetermined percentage of the target pressure.

In an embodiment, a first channel valve is disposed along the pneumatic line, the first channel valve being disposed between the pressure port and the first tire, such as between a supply valve and a first wheel valve. Advantageously, the first channel valve may be opened for inflating the first tire at the calculated tire inflation rate.

Additionally or alternatively, a second channel valve may be disposed along the pneumatic line. The second channel valve may be disposed between the pressure port and the second tire, such as between a supply valve and the second wheel valve. Advantageously, the second channel valve may be opened for inflating the second tire at the calculated tire inflation rate.

For instance, the first and the second channel valves are kept open when the supply valve is closed to interrupt inflation of the first tire and the second tire. This may result in saved time required to control the channel valves and/or to open and/or close them during the inflation process, so that less time is required for inflation overall.

Additionally or alternatively, the first and the second wheel valves are kept open when the supply valve is closed to interrupt inflation of the first tire and the second tire. This may result in saved time required to control the wheel valves and/or to open and/or close them during the inflation process, so that less time is required for inflation overall.

The supply valve may selectively fluidly connect the pressure port to the first channel valve, or may connect the pressure port in parallel to the first channel valve and to the second channel valve.

In one embodiment, the central tire inflation system comprises a common rail and the first tire and the second tire are each connected to the common rail via a rotary manifold, such as via the first channel valve and the second channel valve, respectively.

In one embodiment, at least one pressure sensor for measuring the pressure of the first and/or the second tire is disposed between the first wheel valve and the supply valve and/or between the second wheel valve and the supply valve. For instance, at least one pressure sensor may be disposed on the common rail. This may allow the pressure of one or more tires fluidly connected to the common rail to be measured with the at least one pressure sensor.

In one embodiment, the estimated pressure of the first tire and of the second tire is estimated individually.

In one embodiment, the first tire and the second tire have the same volume and may be disposed on one axle of a vehicle. This may result in the target pressure of the first tire and the second tire being equal. However, there might be other reasons for equal target pressures. Thus, the target pressures of at least two tires, for example of the first tire and the second tire, may be equal. This can be advantageous as an estimated pressure of the at least two tires may be estimated simultaneously. Additionally or alternatively, a real pressure in the at least two tires may be measured simultaneously.

The present disclosure further relates to a central tire inflation system including at least one tire connected to a pressure port for applying an air pressure via a pneumatic line. The central tire inflation system may include a control device configured to perform the following steps:

Receiving an ambient air temperature and a target pressure for the at least one tire and calculating a tire inflation rate based on the ambient air temperature and the target pressure,

Estimating an estimated pressure of the at least one tire based on tire inflation rate, Inflating the at least one tire at the calculated tire inflation rate until the estimated pressure reaches a predetermined percentage of the target pressure,

Measuring a pressure of the at least one tire and calculating a correction factor based on a ratio between the measured pressure and the estimated pressure,

Correcting the tire inflation rate using the correction factor,

Inflating the at least one tire at the corrected tire inflation rate until the target pressure is reached.

An embodiment of the presently proposed method and an embodiment of the presently proposed tire inflation system are described in the following detailed description and are depicted in the accompanying drawings.

### BRIEF DESCRIPTION OF THE FIGURES

FIG. 1 schematically shows a flow diagram illustrating a method for inflating at least one tire of a tire inflation system.

FIG. 2 schematically shows a first configuration of the tire inflation system.

FIG. 3 schematically shows a second configuration of the tire inflation system.

FIGS. 4A and 4B schematically show the second configuration (FIG. 4A) and a third configuration (FIG. 4B) of the tire inflation system.

### DETAILED DESCRIPTION

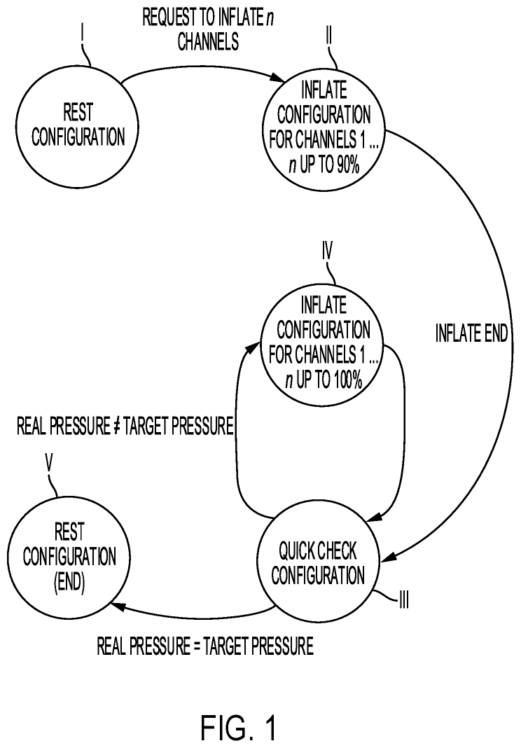

In FIG. 1 a flow diagram illustrates an exemplary method for inflating at least one tire. A central tire inflation system having at least one tire connected to a pressure port for applying an air pressure via a pneumatic line is provided. For instance, each tire is connected to the pneumatic line via one channel valve.

In a first step, the tire inflation system is in a rest configuration I. When a request to inflate the at least one tire is received, a tire inflation rate based on an ambient air temperature and a target pressure is calculated. Based on the calculated tire inflation rate, an estimated pressure of the at least one tire is estimated.

In a second configuration II, the at least one tire is inflated at the calculated tire inflation rate until the estimated pressure reaches a predetermined percentage of the target pressure. In the illustrated example, the predetermined percentage is 90%. When the at least one tire has reached 90% of the target pressure, the inflation is stopped and the system is transferred to a third quick check configuration III.

In the third configuration III, a real pressure of the at least one tire is measured and a correction factor based on a ratio between the measured pressure and the estimated pressure is calculated. The tire inflation rate used to inflate the at least one tire up to 90% is corrected using the correction factor.

In a fourth configuration IV, the at least one tire is inflated at the corrected tire inflation rate until the target pressure is reached, based on the calculation.

Thus, when the at least one tire is presumed to have reached the target pressure, inflation is stopped and the system is transferred to the third quick check configuration III again.

In the third configuration III, the real pressure of the at least one tire is measured. When the real pressure is not equal to the target pressure, a correction factor based on the ratio between the measured pressure and the estimated pressure is calculated. The tire inflation rate used to inflate the at least one tire up to 90% is corrected using the correction factor and the at least one tire is inflated based on the corrected inflation rate.

As long as the real pressure does not correspond to the target pressure, steps III and IV may be repeated. Advantageously, the steps III and IV are performed only once.

When the real pressure is equal to the target pressure (or at least close to the target pressure within set tolerance values) the system is transitioned to an end configuration V. For instance, the end configuration V is equal to the rest configuration I.

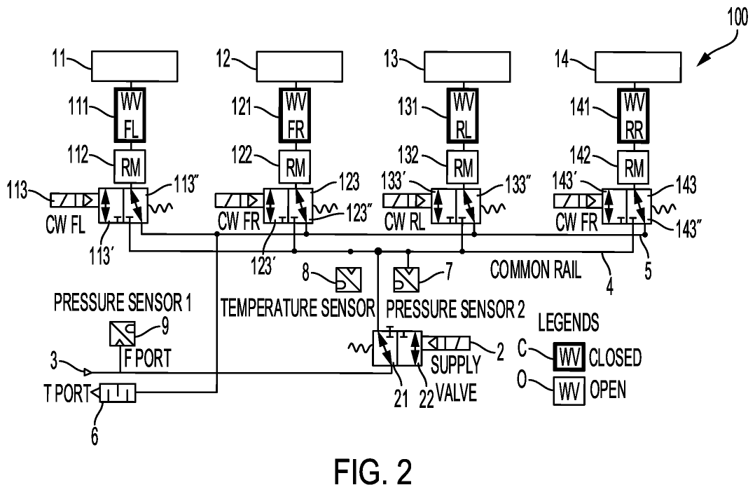

FIG. 2 schematically shows a first configuration of the tire inflation system 100. A control device (not shown) is configured to perform the method steps described in FIG. 1. Four tires 11, 12, 13, 14 are each selectively fluidly connected to a common rail 4 via a wheel valve 111, 121, 131, 141, a rotary manifold 112, 122, 132, 142 and a channel valve 113, 123, 133, 143. The tires 11, 12, 13, 14 typically contain air at a certain pressure which will hereinafter be referred to as tire pressure. For instance, tire 11 and 12 are disposed on the same axle and have the same volume and the same target pressure. For instance, tires 13 and 14 are disposed on the same axle and have the same volume and the same target pressure

A supply valve 2 selectively fluidly connects a pressure port 3 for providing pressurized air with the common rail 4. More specifically, the supply valve 2 and the channel valves 113, 123, 133, 143 are fluidly connected in series between the pressure port 3 and tires 11, 12, 13, 14, respectively.

That is, the supply valve 2 and the first channel valve 113 are fluidly connected in series between the pressure port 3 and the first tire 11, the supply valve 23 and the second channel valve 123 are fluidly connected in series between the pressure port 3 and the second tire, and so on.

The supply valve 2 has an open position 21 and a closed position 22. When the supply valve 2 is switched to its open position 21, the supply valve 2 fluidly connects the pressure port 3 to the common rail 4 and to the channel valves 113, 123, 133, 143. And when the supply valve 2 is switched to its closed position 22, the supply valve 2 fluidly isolates the pressure port 3 from the common rail 4 and from the channel valves 113, 123, 133, 143.

Each of the channel valves 113, 123, 133, 143 may be configured to be selectively placed in either one of a first control position 113′, 123′, 133′, 143′ and a second control position 113″, 123″, 133″, 143″, respectively. For example, in their first control position 113′, 123′, 133′, 143′ the channel valves 113, 123, 133, 143 fluidly connect the first common rail 4 and the supply valve 203 to the tires 11, 12, 13, 14, respectively, and fluidly isolate the respective tires 11, 12, 13, 14 from a second common rail 5. On the other hand, in their second control position 113″, 123″, 133″, 143″, the channel valves 113, 123, 133, 143 fluidly isolate the first common rail 4 and the supply valve 2 from the tires 11, 12, 13, 14, respectively, and fluidly connect the respective tires 11, 12, 13, 14 to the second common rail 5. The second common rail 5 is connected to a tank port 6.

Each of the wheel valves 111, 121, 131, 141 has an open position o and a closed position c. When wheel valve 111 is switched to its open position o, the wheel valve 111 fluidly connects the tire 11 to the channel valves 113 and to the common rail 4. When wheel valve 121 is switched to its open position o, wheel valve 121 fluidly connects the tire 12 to the channel valves 123 and to the common rail 4. When wheel valve 131 is switched to its open position o, the wheel valve 131 fluidly connects the tire 13 to the channel valve 133 and to the common rail 4. When wheel valve 141 is switched to its open position o, the wheel valve 141 fluidly connects the tire 14 to the channel valves 143 and to the common rail 4.

And when the wheel valve 111 is switched to its closed position c, the wheel valve 111 fluidly isolates the tire 11 from the common rail 4 and from the channel valve 113. And when the wheel valve 121 is switched to its closed position c, the wheel valve 121 fluidly isolates the tire 12 from the common rail 4 and from the channel valve 123. When the wheel valve 131 is switched to its closed position c, the wheel valve 131 fluidly isolates the tire 13 from the common rail 4 and from the channel valve 133. When the wheel valve 141 is switched to its closed position c, the wheel valve 141 fluidly isolates the tire 14 from the common rail 4 and from the channel valve 143

A pressure sensor 7 for measuring a pressure in the common rail is disposed on the common rail. A temperature sensor 8 for measuring a temperature is optionally disposed on the common rail 4. Another pressure sensor 9 may be disposed between the pressure port 3 and the supply valve 2.

In FIG. 2, a rest configuration of the inflation system is shown. The wheel valves 111, 121, 131, 141 are in a closed position. The channel valves are in a second control position 113″, 123″, 133″, 143″. The supply valve is in an open position 21.

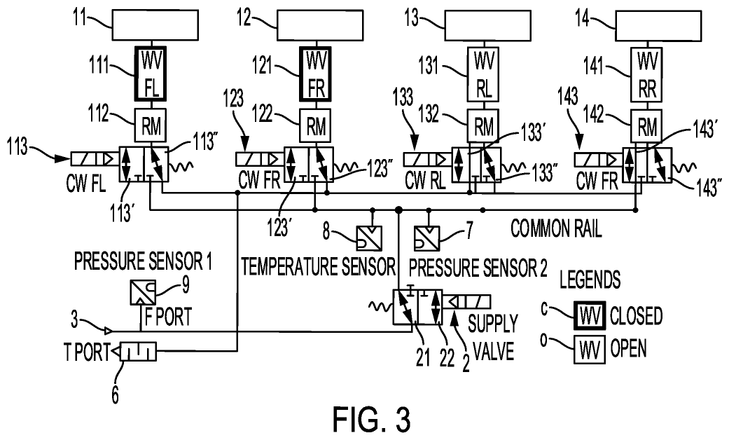

In FIG. 3, the inflation system of FIG. 1 is shown. In FIG. 3, the system is in the second configuration for inflating tires 13 and 14. The wheel valves 131 and 141 are switched to the open position o. The channel valves 133 and 143 are switched to the first control position 133′, 143′. The supply valve 2 and the wheel valves 111, 121 and the channel valves 113, 123 maintain their position as shown in FIG. 2.

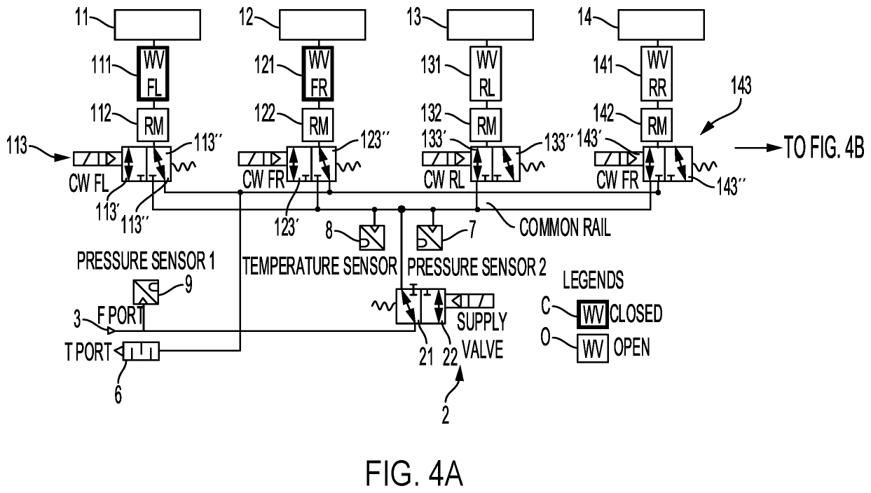

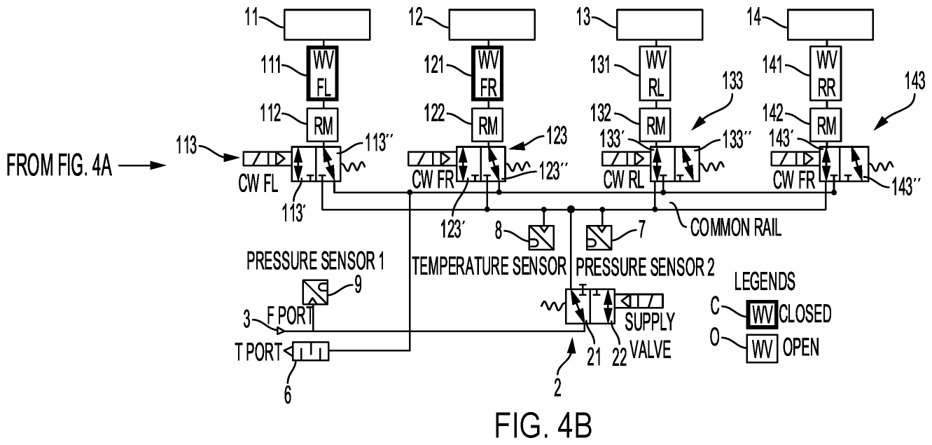

FIGS. 4A and 4B show a transition of the inflation system from a second configuration (inflate configuration) to a quick check configuration (third configuration III). In FIG. 4A the second configuration II is shown, in FIG. 4B the third configuration III is shown. In the third configuration, the wheel valves 131 and 141 and the channel valves 133 and 143 are maintained open. The supply valve 2 is brought to its closed position 22. Thus, an overall inflation time may be decreased. Even though the procedure shown in the figures describes an inflation of the wheels 13 and 14, the wheels 11 and 12 can be inflated in the same way. It is also possible to inflate more than two tires or only one tire at a time.

FIGS. 2-4B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of inflating at least one tire, the method comprising the following steps:
Providing a central tire inflation system having at least one tire connected to a pressure port for applying an air pressure via a pneumatic line,
Receiving an ambient air temperature and a target pressure for the at least one tire and calculating a tire inflation rate based on the ambient air temperature and the target pressure,
Estimating an estimated pressure of the at least one tire based on tire inflation rate,
Inflating the at least one tire at the calculated tire inflation rate until the estimated pressure reaches a predetermined percentage of the target pressure,
Measuring a pressure of the at least one tire and calculating a correction factor based on a ratio between the measured pressure and the estimated pressure,
Correcting the tire inflation rate using the correction factor,
Inflating the at least one tire at the corrected tire inflation rate until the target pressure is reached.

2. The method of claim 1, wherein the predetermined percentage is adjustable.

3. The method of claim 2, wherein the received ambient temperature is assumed to be a predetermined value.

4. The method according to claim 1, wherein the central tire inflation system has at least two tires connected to the pneumatic line.

5. The method according to claim 1, wherein a first wheel valve and a supply valve are disposed along the pneumatic line, the first wheel valve being disposed between the pressure port and a first tire of the at least one tire, the supply valve being disposed between the pressure port and the first wheel valve,
wherein the supply valve and the first wheel valve are opened for inflating the first tire at the calculated tire inflation rate, and
the supply valve is closed to interrupt inflation of the first tire when the estimated pressure reaches the predetermined percentage of the target pressure.

6. The method according to claim 1, wherein a second wheel valve is disposed along the pneumatic line, the second wheel valve being disposed between the pressure port and a second tire of the at least one tire,
wherein the second wheel valve is opened for inflating the second tire at the calculated tire inflation rate, and
the supply valve is closed to interrupt inflation of the first tire and the second tire when the estimated pressure reaches the predetermined percentage of the target pressure.

7. The method according to claim 1, wherein a first channel valve is disposed along the pneumatic line, the first channel valve being disposed between the pressure port and the first tire, preferably between a supply valve and a first wheel valve, wherein the first channel valve is opened for inflating the first tire at the calculated tire inflation rate
and/or
wherein a second channel valve is disposed along the pneumatic line, the second channel valve being disposed between the pressure port and the second tire, preferably between a supply valve and the second wheel valve, wherein the second channel valve is opened for inflating the second tire at the calculated tire inflation rate.

8. The method according to claim 1, wherein the first and the second channel valves are kept open when the supply valve is closed to interrupt inflation of the first tire and the second tire

9. The method according to claim 1, wherein the first and the second wheel valves are kept open when the supply valve is closed to interrupt inflation of the first tire and the second tire.

10. The method according to claim 1, wherein the central tire inflation system comprises a common rail and the first tire and the second tire are each connected to the common rail via a rotary manifold and a/the channel valve.

11. The method according to claim 1, wherein at least one pressure sensor for measuring the pressure of the first and/or the second tire is disposed between the first wheel valve and the supply valve and/or between the second wheel valve and the supply valve, wherein, in particular, at least one pressure sensor is disposed on the common rail.

12. The method according to claim 1, wherein the estimated pressure of the first tire and of the second tire is estimated individually.

13. The method according to claim 1, wherein the first tire and the second tire have the same volume and are preferably disposed on one axle of a vehicle.

14. The method according to claim 1, wherein the target pressures of the first tire and the second tire are equal.

15. A central tire inflation system including at least one tire connected to a pressure port for applying an air pressure via a pneumatic line and a control device configured to perform the following steps:
receiving an ambient air temperature and a target pressure for the at least one tire and calculating a tire inflation rate based on the ambient air temperature and the target pressure,
estimating an estimated pressure of the at least one tire based on tire inflation rate,
inflating the at least one tire at the calculated tire inflation rate until the estimated pressure reaches a predetermined percentage of the target pressure,
measuring a pressure of the at least one tire and calculating a correction factor based on a ratio between the measured pressure and the estimated pressure,
correcting the tire inflation rate using the correction factor,
inflating the at least one tire at the corrected tire inflation rate until the target pressure is reached.

16. A method of inflating at least one tire coupled with a central tire inflation system, the at least one tire connected to a pressure port for applying an air pressure via a pneumatic line, the method comprising:
calculating a tire inflation rate based on an ambient air temperature and a target pressure,
determining an estimated pressure of the at least one tire based on the calculated tire inflation rate,
increasing inflation of the at least one tire based on the calculated tire inflation rate only until the estimated pressure increases up to within a threshold of the target pressure, and then increasing the inflation at an adjusted tire inflation rate based on a ratio between a measured tire pressure and the estimated pressure until the target pressure is reached.
